(19) United States
(12) Patent Application Publication
(10) Pub. No.: US 2006/0169469 A1
(43) Pub. Date: Aug. 3, 2006

(54) Device for establishing an electrical conductor in a conduit

(75) Inventors: Kenneth Brian Eastwood, Fort Collins, CO (US); Sondra Kay Eastwood, Fort Collins, CO (US)

Correspondence Address: CR MILES, P.C., Suite 200 B, 1 Old Town Square, Fort Collins, CO, 80524, US

(73) Assignee: E5 Products, Inc.

(21) Appl. No.: 11/046,581

(22) Filed: Jan. 28, 2005

(51) Int. Cl. H02G 15/22

(52) U.S. Cl. 174/19

(57) ABSTRACT

Generally, a device and method for establishing electrical conductors in a conduit. Specifically, a flexible body which couples to the end of the conduit to assist in drawing the electrical conductors through the conduit.

### BACKGROUND

Generally, devices and methods which can be used establish a conductor within a conduit. Specifically, a flexible body having a hollow interior through which electrical conductors can be drawn which couples to the end of a conduit to assist in establishing the electrical conductors in the conduit.

Numerous and varied insulated electrical conductors, transmission cables, optical fibers, and the like, are established inside tubular conduit. The conduit acts to isolate and protect the electrical conductors, transmission cables, optical fibers, or the like, from manipulation and damage. Certain precautions are taken as electrical conductors, transmission cables, and optical fibers are established in conduit to prevent damage to the conduction or transmission properties of the wire, cable, or fiber; or to the insulation surrounding the wire, cable or fiber. The manner in which electrical conductors can be established within a conduit without damage can be limited by certain physical properties of the conductor, cable or fiber.

For example, an electrical conductor may have a recommended minimum bending radius. The minimum bend radius is the radius of curvature that a flat or round wire, metallic cable, or optical fiber can bend without any adverse effects. A bend radius value is usually expressed as a whole number multiple of the conductor, cable, or fiber's overall diameter. As a non-limiting example, the Insulated Cable Engineers Association recommends a minimum bending radius of eight (8) times the overall diameter of single or multiple conductor cables. Therefore, if the diameter of a single conductor cable is 0.25 inch the minimum bending radius of the cable would be 2.00 inches.

In this regard, a significant problem related to establishing electrical conductors, cables, fibers, or the like in conduit can be damage to the conductor, cable or fiber due to the angle formed in the conductor, cable, or fiber as it is drawn out of the end of the conduit. Engagement of the conductor, cable, or fiber with the conduit wall at the end of the conduit can form a radius at the vertex of the angle having less than the minimum bending radius recommended for the electrical conductor, cable, or fiber. As a result, the electrical conductor may become damaged.

The electrical conductor, cable, or fiber may also have a manufacturer's recommended maximum pulling tension which may not be exceeded without damage to the electrical conductor. Maximum pulling tension on a cable for the entire route through a conduit can be calculated by Tm=K×n×CMA where Tm=maximum pulling tensin (lbs.), K=constant of 0.008 for copper conductors and 0.006 for aluminum conductors, n=number of conductors, and CMA=circular mil area for a single conductor. Utilizing various other factors, the pulling tension of a conduit can be calculated whether the conduit is straight, bent, or has angles.

In this regard, a significant problem with pulling electrical conductors through a conduit can be that the electrical conductor can be damaged because the maximum pulling tension is exceeded. As described above, electrical conductors, cables, or fibers can be pulled through a conduit in a manner in which the end of the conduit or the fitting at the end of the conduit engages the exterior surface of the cable or electrical conductor. When the end of the conduit or fitting at the end of the conduit engages the exterior surface of the electrical conductor, cable, or fiber the level of resistance to transfer of the cable through the conduit increases and correspondingly the amount of tension applied may be increased. Because engagement of the electrical conductor, cable, or fiber with the end of the conduit may be intermittent, the level of resistance to transfer the cable through the conduit can correspondingly increase and decrease making application of uniform tension on the cable difficult to maintain. Under these circumstances, the maximum pulling tension may be inadvertently exceeded with consequent damage to the electrical conductor.

Even in those circumstances in which the minimum bending radius or the maximum pulling tension is not exceeded, engagement of the electrical conductor, cable, or fiber with the end of the conduit can damage the surrounding insulation. Damage to the insulator may subsequently result in arcing of electrical conductors or interfere with the transmission properties of the cable or fiber.

Another significant problem with establishing electrical conductors, cables, or fibers in a conduit can be that the electrical conductor, cable, or fiber is cut at a location too close the end of the conduit. A suitable length of electrical conductor, cable, or fiber must extend beyond the end of the conduit to allow the electrical conductor, cable, or fiber to make the terminal connection. Often person(s) that pull electrical conductors, cables, or fibers through the conduit do not know or have a measure available to make certain that a suitable length of the electrical conductor extends beyond the end of the conduit to make terminal connections. Once cut too short to make the terminal connection desired or required the electrical conductor may have to be replaced or modified.

The instant invention addresses each of these significant problems.

### SUMMARY OF THE INVENTION

Accordingly, a broad object of the invention can be to provide devices and methods to establish conductors, cables, fibers, or the like, in a conduit which operate in a manner which limits or avoids exceeding the minimum bending radius, exceeding the maximum pulling tension, damage to the surrounding insulator, or cutting the electrical conductor at a location which yields insufficient length to effect the terminal connection.

Another broad object of the invention can be to provide a tubular body having a first terminal portion configured to couple to an end of a conduit such tubular body acting upon such electrical conductors, cables, fibers, or the like, to avoid exceeding the minimum bending radius.

Another broad object of the invention can be to provide a tubular body having a first terminal portion configured to couple to an end of a conduit such tubular body acting upon such electrical conductors, cables, fibers, or the like, to avoid exceeding the maximum pulling tension.

Another broad object of the invention can be to provide a flexible tubular body having a first terminal portion which defines a first aperture that couples to an end of a conduit and a body portion having sufficient flexure to position a second terminal portion at an angle with respect the longitudinal axis of the conduit to provide a second aperture through which electrical conductors, cables, fibers, or the like, can be drawn.

Another broad object of the invention can be to provide a retractably extensible tubular body having a first terminal portion configured to couple to the end of a conduit and which can be axially extended to position a second terminal portion at a location with respect to the end of the conduit to provide a second aperture through which electrical conductors, cables, fibers, or the like, can be drawn.

Another broad object of the invention can be to provide a retractably extensible tubular body having a first terminal portion configured to couple to the end of the conduit and which can be axially extended or retracted to identify a range of locations on the electrical conductor at which to cut the electrical conductor to leave a sufficient portion of the electrical conductor to make terminal connections.

Naturally, further objects of the invention are disclosed throughout other areas of the specification, drawings, photographs, and claims.

### A BRIEF DESCRIPTION OF THE DRAWINGS

FIG. 1 provides a side view of a particular embodiment of the invention which includes a flexible body having a terminal portion configured to insert the end of conduit.

FIG. 2 provides a side view of the particular embodiment of the invention shown in FIG. 1 rotated 90 degrees about the longitudinal axis.

FIG. 3 provides an isometric view of the particular embodiment of the invention shown by FIGS. 1 and 2.

FIG. 4 provides a side view of a particular embodiment of the invention which includes flexible body having a terminal portion annularly engaged to a compression collar.

FIG. 5 provides a side view of the particular embodiment of the invention shown in FIG. 4 rotated 90 degrees about the longitudinal axis.

FIG. 6 provides an isometric view of the particular embodiment of the invention shown by FIGS. 4 and 5.

FIG. 7 provides a side view of a particular embodiment of the invention which includes a flexible body having a terminal portion spirally threaded on the interior surface.

FIG. 8 provides a side view of the particular embodiment of the invention shown in FIG. 7 rotated 90 degrees about the longitudinal axis.

FIG. 9 provides an isometric view of the particular embodiment of the invention shown by FIGS. 7 and 8.

FIG. 10 provides a side view of a particular embodiment of the invention which includes a flexible body having a terminal portion spirally threaded on the interior surface with a longitudinal slot.

FIG. 11 provides a side view of the particular embodiment of the invention shown in FIG. 10 rotated 90 degrees about the longitudinal axis.

FIG. 12 provides an isometric view of the particular embodiment of the invention shown by FIGS. 10 and 11.

FIG. 13 provides a side view of a particular embodiment of the invention which includes a flexible body having a terminal portion configured to provide a tubular neck and a collar rotationally engaged to the tubular neck.

FIG. 14 provides a side view of the particular embodiment of the invention shown in FIG. 13 rotated 90 degrees about the longitudinal axis.

FIG. 15 provides an isometric view of the particular embodiment of the invention shown by FIGS. 13 and 14.

FIG. 16 provides a side view of a particular embodiment of the invention which includes a flexible body which provides a convoluted body wall and a terminal portion configured to provide a tubular neck and a collar rotationally engaged to the tubular neck.

FIG. 17 provides a side view of the particular embodiment of the invention shown in FIG. 16 rotated 90 degrees about the longitudinal axis.

FIG. 18 provides an isometric view of the particular embodiment of the invention shown by FIGS. 16 and 17.

FIG. 19 provides a side view of a particular embodiment of the invention which includes a flexible body which provides a convoluted body wall and a terminal portion configured to provide a tubular neck and a collar rotationally engaged to the tubular neck.

FIG. 20 provides a side view of the particular embodiment of the invention shown in FIG. 19 rotated 90 degrees about the longitudinal axis.

FIG. 21 provides an isometric view of the particular embodiment of the invention shown by FIGS. 19 and 20.

FIG. 22 provides an illustration of a particular method of using the various embodiments of the invention described herein or shown by FIGS. 1-21.

### DETAILED DESCRIPTION OF THE PREFERRED EMBODIMENTS

Generally, devices and methods for establishing an electrical conductor in a conduit. a flexible body having a hollow interior through which electrical conductors can be drawn which couples to the end of a conduit to assist in establishing the electrical conductors in the conduit.

The term “conductor” is used generically herein to describe the numerous and varied types and kinds of conductors, electrical conductors, cables, transmission cables, fibers, optical fibers, or the like, which can be established in conduit. A non-limiting example of a conductor is an insulated electrically conductive wire. The conductive wire can vary in diameter which can be identified by the gauge. For example, American Wire Gauges (“AWG gauges”) refer to wires having a specific diameter or area in cross section. The higher the AWG gauge the smaller the diameter of wire. For example, AWG gauge wire has a diameter of 0.2893 inches while AWG gauge wire has a diameter of 0.008 inches. While the wire can comprise any manner of electrically conductive material, typically, the wire comprises a copper wire or an aluminum wire which can comprise a single strand, or multiple strands of wire which may further be braided, twisted, or the like.

The term “insulation” or “insulator” is used generically herein to describe the numerous and varied non-electrically conductive materials in which a conductorr can be established. Non-limiting examples of an insulator in accordance with the invention comprise fiberglass, polyvinyl chloride, nylon, polypropylene, Dacron®, Nomex®, Kevlar®, Spectra®, silicon rubber, vinyl, acrylic, fluoropolymer, TFE, FEP, PFA, Teflon® whether configured as a continuous layer of material (smooth or convoluted), a sleeve, spiral wrapped, braided, or the like.

The term “conduit” is used generically herein to describe any manner of tube regardless of the exterior geometry which defines a passage in which a conductor or a plurality of conductors can be established. Typically, conduit has a tubular configuration in which a conduit wall of circular cross section defines a interior passage having a particular diameter. For many applications, the diameter can be between about one-half inch and about one and one-half inches; however, this range is not intended to be limiting with regard to the diameter of conduits in which electrical conductors can be established and can be of any lesser or greater interior diameter. The conduit wall may vary in thickness, even though the interior passage may retain substantially the same interior passage diameter. Conversely the conduit wall may vary in thickness and the interior passage diameter may accordingly vary to retain a substantially constant external diameter of the conduit. Conduit can be obtained in a variety of materials, such as, aluminum, non-metallic polyvinylchloride, polyvinyl chloride exterior coated rigid metal, urethane interior coated metal, stainless steel conduit, galvanized steel, brass, flexible metal, corrugated metal, corrugated plastic, polyethylene, nylon, nylon wire loom conduit, chrome corrugated metal, polytetrafluoroethylene, or zinc-coated metal, among numerous others without limitation. The term “conduit end” or “end of the conduit” is generically used herein to describe the terminal end of a conduit whether the end of a continuous segment of conduit or the end of fitting coupled to the end of a conduit.

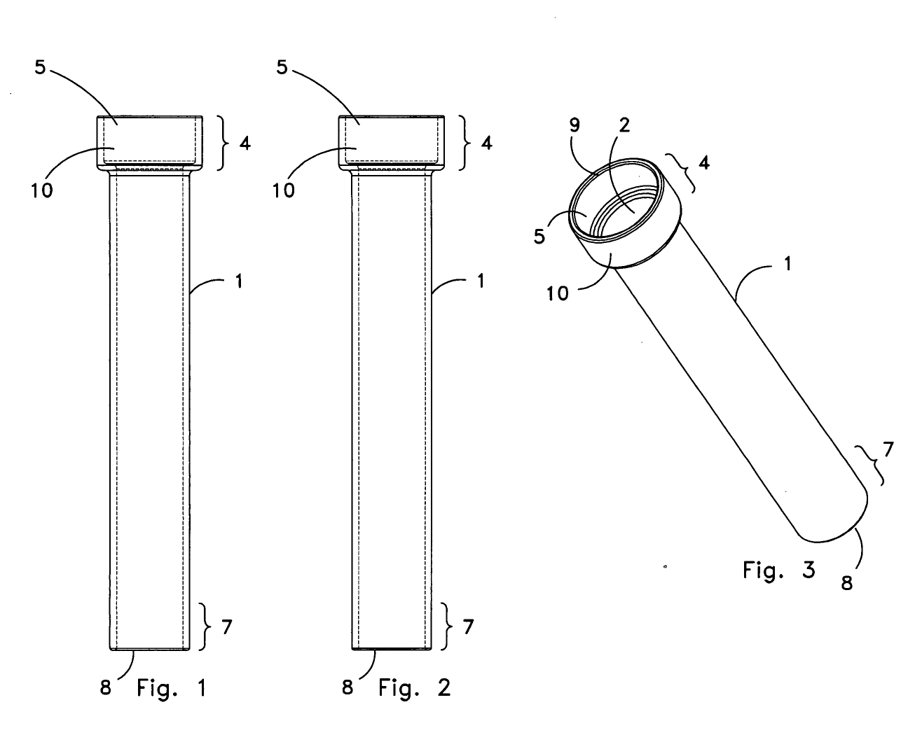

Now referring primarily to FIG. 1, the invention can comprise a flexible body (1) having a hollow interior (2) through which a conductor (an exemplary embodiment of an electrical conductor is shown by FIG. 8 and above-described)(3) can be drawn. A first terminal portion (4) of the flexible body (1) can be configured to provide a first aperture element (5) that can be coupled to a first conduit end (6)(such as the exemplary embodiment of a conduit is shown by FIG. 8 and as above-described). A second terminal portion (7) of the flexible body (1) can be configured to provide a second aperture element (8) to allow various types of conductors (3), such as insulated electrical conductors, to pass through the hollow interior (2).

The flexible body (1) can provide a flexible body wall (9) configured or formed from numerous and varied thermoplastic materials, individually or in various combinations, permutations, or mixtures, such as, Teflon®, polyvinylidene difluoride (PVDF), FEP teflon, PFA teflon, PTFE teflon, polyvinylchloride (PVC), braid reinforced PVC, Santoprene®, polyethylene, polypropylene, high density polyethylene, high density polyethylene with between about 10% to about 35% polypropylene, Viton®, polyurethane, nylon, nylon 11, vinyl, polybutylene, polyetheretherketon (PEEK), or the like. The material selected can be matched to the body wall configuration and the application to provide the necessary or desired flexure of the flexible body wall (9), lubricity of the interior surfaces of the flexible body wall (9), and as to certain embodiments to maintain the flexed, extended, or retracted condition where high density polyethylene or a copolymer of high density polyethylene with between about 10% to about 35% polypropylene is preferred.

Now referring primarily to FIGS. 1-5, various exemplary non-limiting embodiments of the first terminal portion (4) of the flexible body (1) are shown. As shown, the flexible body (1) can be configured as an elongated tubular body (1) with a flexible body wall (9) of substantially uniform thickness having sufficient resilient flexure in the first terminal portion to allow the end of a conduit (6) or a terminal fitting coupled to the conduit (6) to be inserted into the first aperture element (5). Engagement of the interior surface of the flexible body wall (9) at the first terminal portion (4) of the flexible body (1) with the exterior surface of the end of the conduit (6) can fix the flexible body (1) to the end of the conduit (6) to allow a single or a plurality of electrical conductors (3) to be drawn through the hollow interior (2) of the flexible body (1).

With respect to certain embodiments of the invention as shown by FIG. 1, the first terminal portion (4) of the flexible body (1) can further include a flexible neck (10) having an internal diameter that mates with the end of the conduit (6). The flexible body (1) can maintain singular configuration while the flexible neck can be provided in a graded series of different configurations to mate with a variety of different conduit (6) geometries.

Now referring primarily to FIG. 2, certain embodiments of the flexible neck can further comprise a compression collar (11). The exemplary embodiment of the compression collar (11) shown by FIG. 2 provides for a pair flanges (12) projecting outwardly from the compression collar (11). At least one of the pair of flanges can have a spirally threaded aperture (13) in which a capped rod (14) having a mated spiral thread (15) operates to reduce the slot width (16) between the pair of flanges (14) thereby reducing the inside diameter of the compression collar (11) which correspondingly reduces the internal diameter of the first aperture element (5) to engage the exterior surface of the end of the conduit (6). The description of this embodiment of the compression collar (11) is not meant to limit the wide variety of compression collars that can be used in accordance with the invention which act upon the flexible neck (10) of the first terminal portion (4) of the flexible body (1) to reduce the inside diameter of the first aperture element (5).

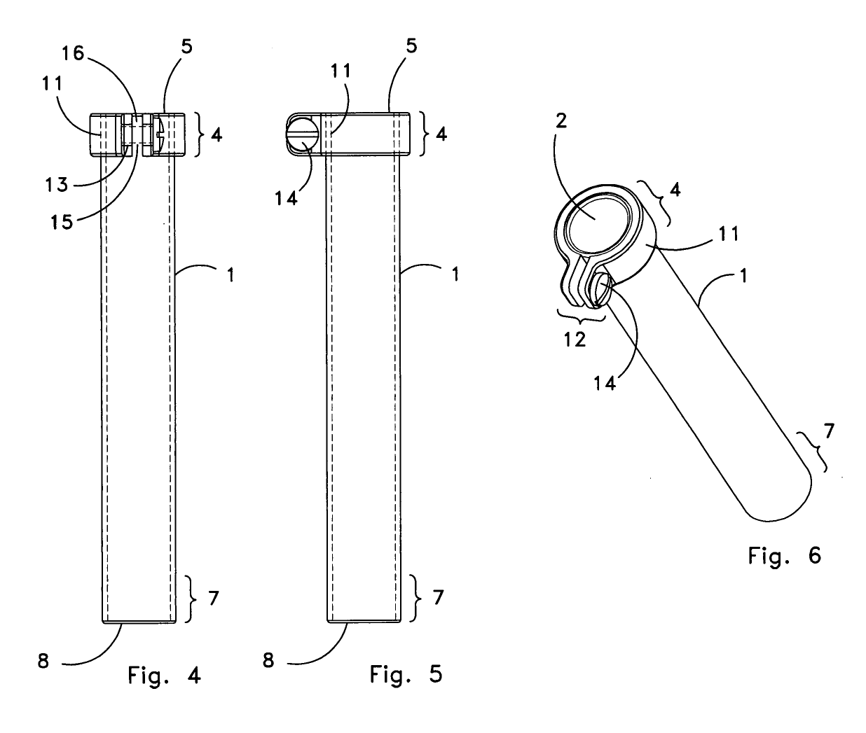

Now referring primarily to FIG. 3, certain embodiments of the invention can provide a terminal portion of the flexible body (1) having a spiral thread (16) coupled to interior surface. The spiral thread (16) can be configured to rotatably mate with a second spiral thread (17)(as shown by FIG. 8) coupled to the exterior surface of the end of the conduit (6). As shown by FIG. 4, certain embodiments of first terminal portion (4) having a spiral thread (16) can further include a longitudinal slot (18) to increase radial flexibility of the first terminal portion (4) to allow the spiral thread to mate readily with the corresponding second spiral thread (17) coupled to the end of the conduit (6). Now referring back to FIG. 2, the compression collar (11) can be utilized with the embodiment of the first terminal portion (4) shown by FIG. 4 to increase frictional engagement between the spiral thread (16) coupled to the interior of the first terminal portion (4) and the second spiral thread (17) coupled to the end of the conduit (6).

Now referring to FIG. 5, certain embodiments of the invention provide a first terminal portion (4) which includes a tubular neck (19) and further including a rotationally engaged collar (20). The travel of the collar (20) on the longitudinal axis of the tubular neck (19) can be limited by a first annular flange (21) connected to the exterior surface of the tubular neck (19) which engages a second annular flange (22) connected to the interior surface of the collar (20). A spiral thread (23) can be coupled to the interior surface of the collar (20) configured to mate with the second spiral thread (17) coupled to the end of the conduit (6).

Now referring to FIG. 6, certain embodiments of the invention can provide a portion of the flexible body (1) having a convoluted body wall (24). With respect to certain embodiments of the invention the portion of the flexible body (10) having a convoluted body wall (24) can have increased flexure relative to the non-convoluted portion of the body wall (9). The convoluted body wall (24) can provide sufficient flexure to locate the second aperture element (8) at an angle of between zero degrees and about forty-five degrees relative to the longitudinal axis (25) of the flexible body (1) which passes through the first aperture element (4) and the second aperture element (8) in the unflexed condition. As to other embodiments of the invention, the flexure of the convoluted body wall (24) may allow an angle of between zero and about ninety degrees relative to the longitudinal axis (25) of the flexible body (1) which passes through the first aperture element (4) and the second aperture element (8) in the unflexed condition.

The convoluted body wall (24) can be configured in numerous ways to allow the flexure above-described. In one exemplary non-limiting embodiment as shown by FIG. 6, a plurality of annular ribs (26) can be spaced a distance apart along the longitudinal axis of the flexible body (1) interconnected by a retractably extensible body wall (27). The retractably extensible body wall (27) interconnected to the annular ribs (26) can have a thickness which retracts and extends in accordion-like fashion under forcible flexure of the convoluted body wall (24). By varying the diameter and the longitudinal spacing of the annular ribs (26) and thickness of the retractable extensible body wall (27) interconnected to the annular ribs (26) in various permutations and combinations the maximum and minimum amount of forcible flexure of the retractably extensible body wall (27) can be controlled. Similarly, by varying the cross sectional geometry of the annular ribs (26), the longitudinal spacing between the annular ribs (26) and the thickness of the retractably extensible body wall (27) interconnected to the annular ribs (26) in various permutations and combinations the maximum and minimum amount of forcible axial extension and retraction of the retractably extensible body wall (27) can be controlled to allow adjustment of the length of the flexible body along the longitudinal axis of the flexible body (1) in the unflexed condition.

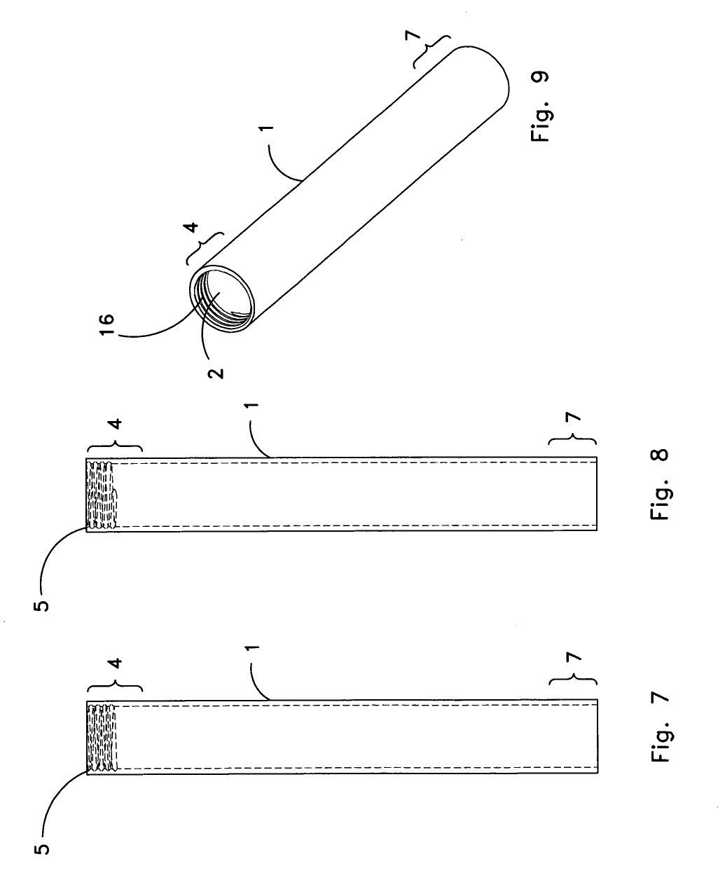

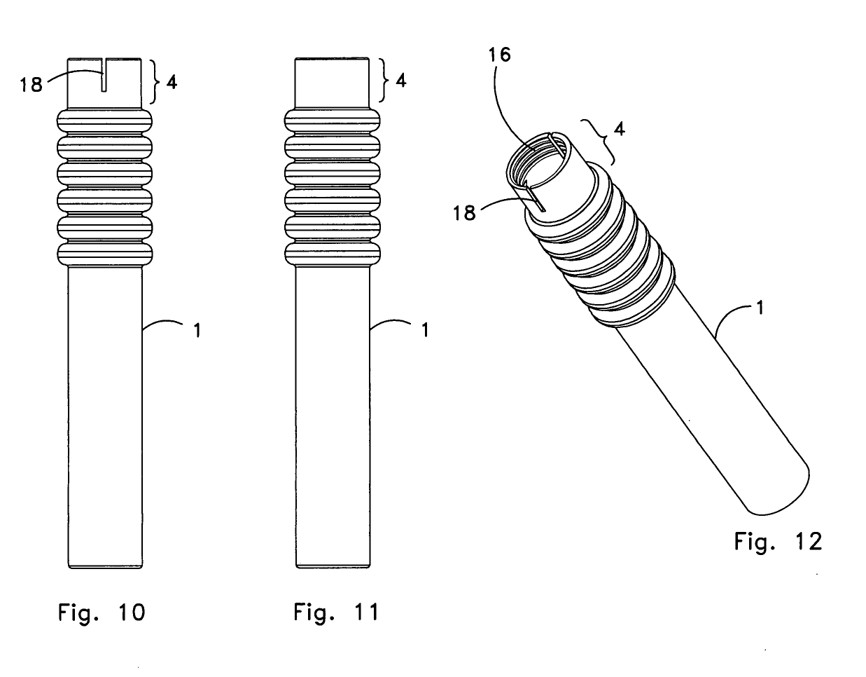

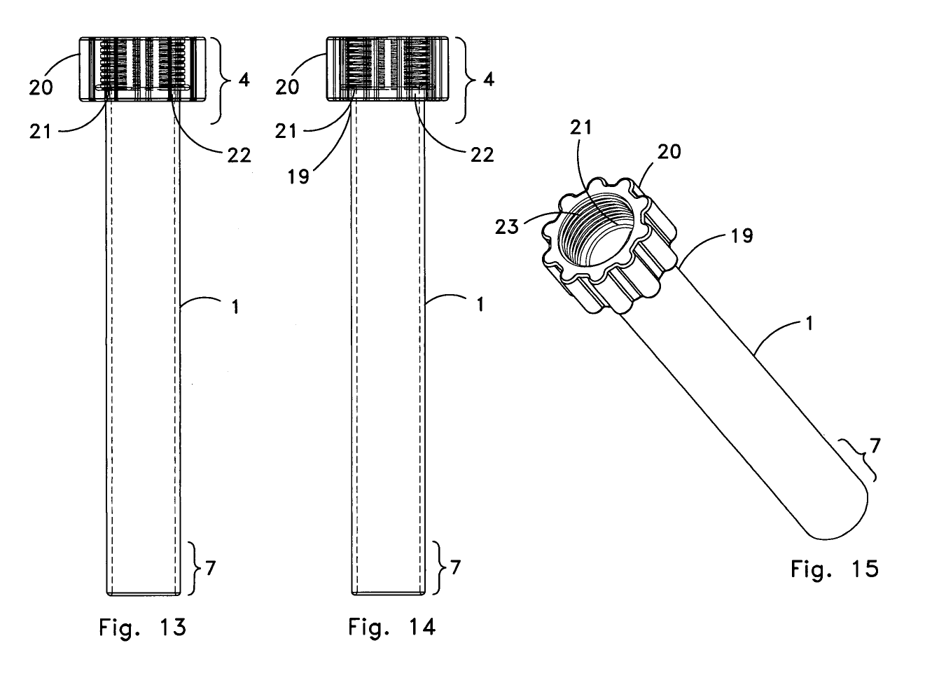

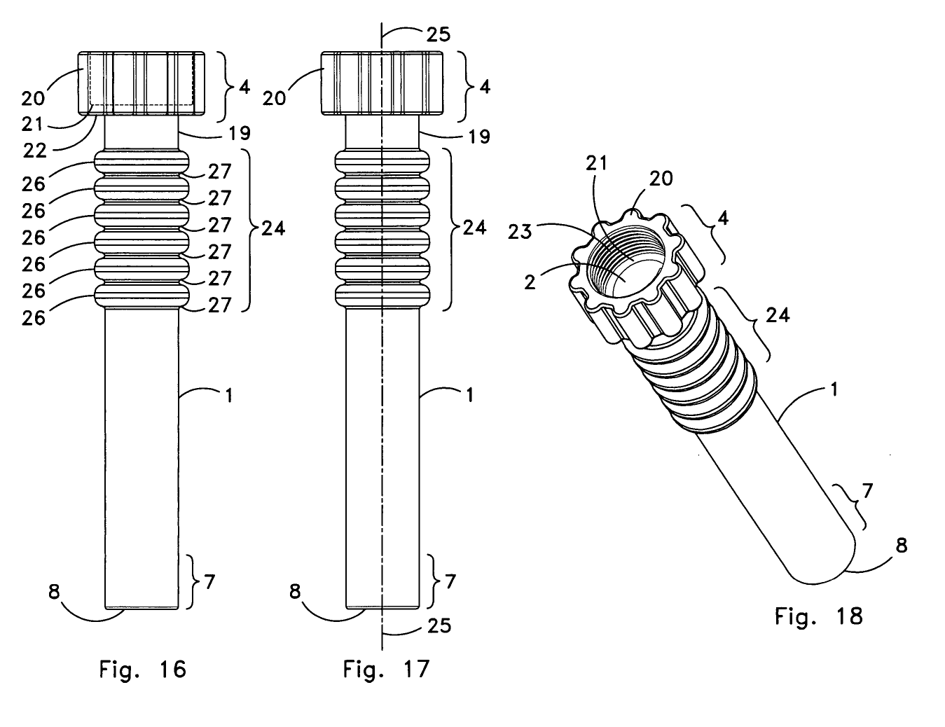

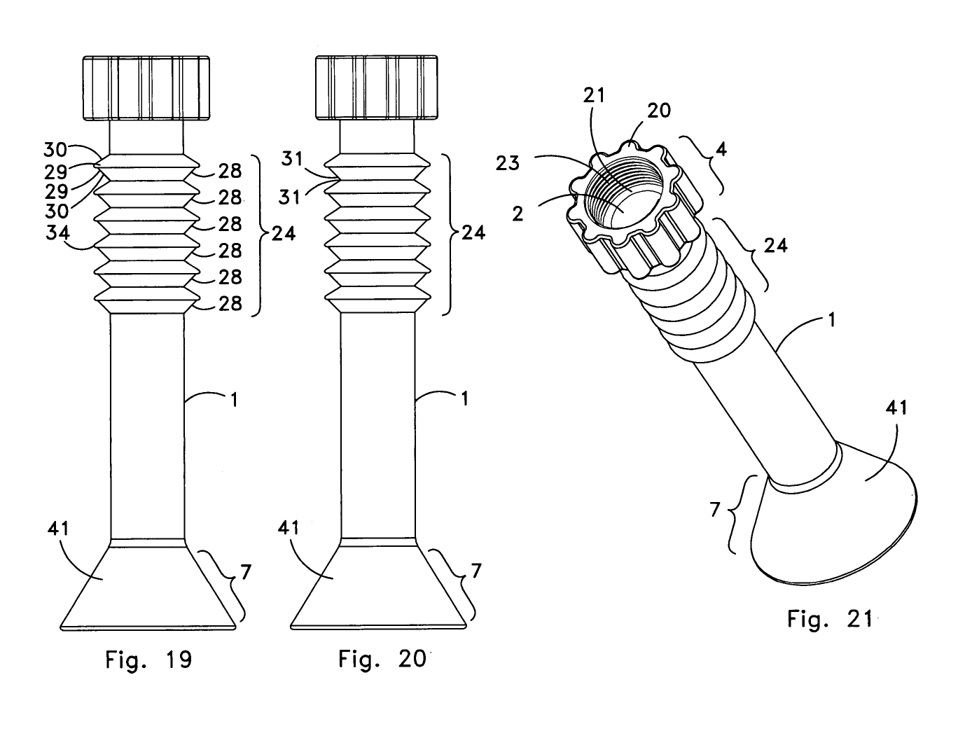

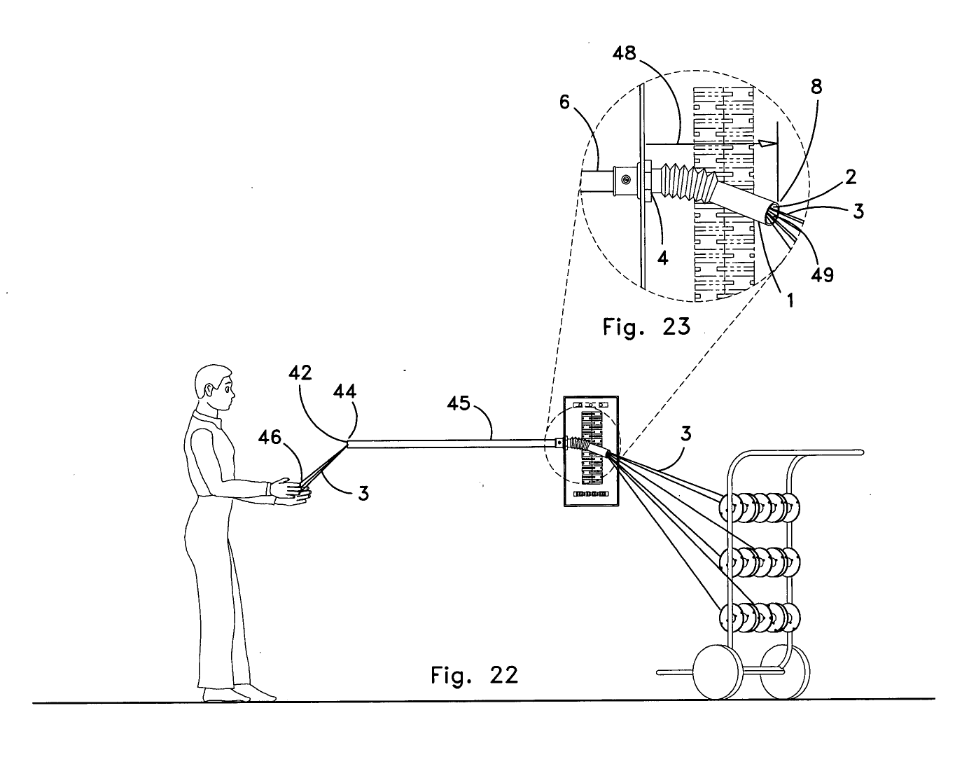

Now referring to FIG. 7, the convoluted body wall (24) can be configured as a plurality of opposed frustoconical segments (28). Each of the plurality of opposed frustoconical segments (28) can be generated by joining the greater diameter ends (29) of a pair of frusta (30). The lesser diameter ends (31) of the opposed frustoconical segments (28) are then joined to form the convoluted body wall (24).

As to certain embodiments of the invention, the frusta walls (32) can be of substantially uniform thickness as each radially converges from the joined larger diameter ends (29) toward the joined lesser diameter ends (31). Embodiments of the invention having frusta walls (32) of substantially uniform thickness may maintain a single configuration unless forcibly flexed or forcibly extended or retracted along the longitudinal axis of the flexible body.

As to other embodiments of the invention, the frusta walls (32) can taper (33) as they converge radially from the joined larger diameter ends (29) toward the joined lesser diameter ends (31). Embodiments of the invention having frusta walls (32) that taper (33) in this manner may be flexed using less lateral or axial force. Additional particular embodiments of the invention, can further include larger diameter ends (29) of the opposed frusta (30) which join at a annular rib (34) having a curved section (35) joined to the larger diameter end (31) of a first frusta (36) and a planar section (37) which projects a distance radially inward perpendicular to the longitudinal axis of the flexible body (1) in the unflexed condition to join the larger diameter end (31) of a second frusta (38). In these particular embodiments of the invention, the frusta walls (32) can progressively increase in thickness as they converge from the planar section (37) to the lesser diameter ends (31). Upon being forcibly flexed, extended or retracted these embodiments of the invention can maintain the last chosen forcibly flexed, extended, or retracted condition.

Again referring to FIG. 7, the various embodiments of the can further include a second terminal portion (7) configured as a terminal frusta (39) joined to the flexible body (1) by the terminal frusta lesser diameter end (40). The angle and length of the terminal frusta wall (41) which converge to join the flexible body (1) can vary to adjust the geometry of the second aperture element (8). As to certain particular embodiments of the invention, the angle of the terminal frusta wall (41) can be about forty-five degrees relative to the longitudinal axis of the flexible body in the unflexed condition.

Now referring to FIG. 8, the various embodiments of the invention can be used to establish a single or a plurality of electrical conductors (3) in a passage (42) which communicates between a first conduit end (6) and a second conduit end (44). The first conduit end (6) or the terminal fitting coupled to the first conduit end (6) can be inserted into the first aperture element (5) of the flexible body (1) to provide communication the passage (42) of the conduit (45) and the hollow interior (2) of the flexible body (1) which communicates between a first aperture element (5) of the first terminal portion (4) and a second aperture element (8) of a the second terminal portion (7).

As to those embodiments of the invention which provide a spiral thread (16)(23) coupled to the interior surface of the first terminal portion (4) of the flexible body (1), the spiral thread (16)(23) can be rotationally coupled to the second spiral thread (17) coupled to the exterior surface of the first conduit end (6) or terminal fitting.

As to those embodiments of the invention which provide a compression collar (11), the compression collar (11) can be adjusted to provide increased frictional engagement between the interior surface of the first terminal portion (4) of the flexible body (1) and the exterior surface of the first conduit end (6).

Regardless of the manner of coupling the various embodiments of the first terminal portion (4) of the flexible body (1) to the first end of the conduit (6), communication between the passage (42) within the conduit (45) can be established with the hollow interior (2) of the flexible body (1) such that a single or a plurality of electrical conductors (3) can be feed or drawn into the second aperture element (8) of the second terminal portion (7) of the flexible body (1). As to certain applications a fish tape can be feed into the conduit passage (42) from the second end of the conduit (44) and out of the second aperture element (8) of the second terminal portion (7) of the flexible body (1). The electrical conductors (3) can be attached to a fish tape and drawn into the second aperture element (8) and through the hollow interior (2) of the flexible body (1) into the passage (42) of the conduit (45). The electrical conductors (3) can be drawn from the second conduit end (44) to establish the conductor end(s)(46) a distance beyond the second conduit end (44).

As to certain embodiments of the invention which maintain a last chosen flexed condition, prior to drawing the electrical conductors (3) through the hollow interior (2) of the flexible body (1), the flexible body (1) can be flexed to maintain a flexed condition in which the electrical conductors (3) can be drawn through the hollow interior (2) of the flexible body (1) and the passage (42) of the conduit (44) with less pulling tension or to provide a radius of the interior surface of the flexible body (1) which exceeds the minimum bending radius of the conductor(s)(3). By establishing the flexed condition of the flexible body to reduce pulling tension and to exceed the minimum bending radius of the conductor(s)(3) less effort can be used to establish the conductor(s)(3) in the passage (42) of the conduit (45) and there can be a reduced likelihood of damage to the conductor(s)(3).

As to certain embodiments of the invention which have a convoluted body wall (24), the extended or retracted condition of the flexible body (1) can be achieved prior to drawing or pulling the conductor(s)(3) through the hollow interior (2) of the flexible body (1). In certain instances the extended condition of the flexible body (1) can be utilized to position the second aperture element (8) at a location which projects beyond the height of the side walls (46) of a junction box (47), or other structural component, or to position the second aperture element (8) at a location a distance from the side walls (46) of the junction box (47), or other structural component, to avoid engagement between the conductor(s)(3) and the side walls (46) of the junction box (47).

As to other embodiments of the invention which have a convoluted body wall (24), the extended or retracted condition of the flexible body can further be utilized as a measure (48) to indicate where the conductor(s)(3) should be cut. For example, after establishing electrical conductors (3) in the passage (42) of the conduit (45), the retracted condition or the extended condition of the flexible body (1) can position the end of the second terminal portion (8) at a location relative to the electrical conductor (3) which identifies the location (49) on the electrical conductor (3) where it can be cut to leave the proper portion of the electrical conductor (3) extending beyond the first conduit end (6).

As can be easily understood from the foregoing, the basic concepts of the present invention may be embodied in a variety of ways. The invention involves numerous and varied embodiments of a device which assists in drawing electrical conductors through a conduit and methods of making and using such device.

As such, the particular embodiments or elements of the invention disclosed by the description or shown in the figures accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “flexible body” should be understood to encompass disclosure of the act of “flexing a body”—whether explicitly discussed or not—and, conversely, were there effectively disclosure of the act of “flexing a body”, such a disclosure should be understood to encompass disclosure of a “flexible body” and even a “means for flexing a body.” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

Thus, the applicant(s) should be understood to claim at least: i) each of the devices used to establish an electrical conductor in a conduit herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The claims set forth in this specification are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth below are intended describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1-27. (canceled)

28. A device to establish an electrical conductor in a conduit, comprising:
a. a flexible body having a hollow interior through which said electrical conductor can be drawn;
b. a first terminal portion of said flexible body configured to provide a first aperture element which couples to an end of said conduit; and
c. a second terminal portion of said flexible body having a second aperture element configured to allow said electrical conductor to pass through.

29. A device to establish an electrical conductor in a conduit as described in claim 28, wherein said flexible body comprises a tubular flexible body.

30. A device to establish an electrical conductor in a conduit as described in claim 29, wherein said tubular flexible body has a body wall of substantially uniform thickness.

31. A device to establish an electrical conductor in a conduit as described in claim 28, wherein a portion of said tubular flexible body further comprises a convoluted body wall.

32. A device to establish an electrical conductor in a conduit as described in claims 28, wherein said tubular flexible body has a longitudinal axis in the unflexed condition which passes through said first aperture element and said second aperture element, and wherein said convoluted body wall has a configuration which allows sufficient flexure of said tubular flexible body to alter direction of said longitudinal axis which passes through said second aperture element to an angle of between zero degrees and at least forty five degrees relative to said longitudinal axis in the unflexed condition.

33. A device to establish an electrical conductor in a conduit as described in claim 32, wherein said tubular flexible body has a longitudinal axis in the unflexed condition which passes through said first aperture element and said second aperture element, and wherein said convoluted body wall has a configuration which allows sufficient flexure of said tubular flexible body to alter direction of said longitudinal axis which passes through said second aperture element to an angle of between zero degrees and at least forty five degrees relative to said longitudinal axis in the unflexed condition.

34. A device to establish an electrical conductor in a conduit as described in claim 33, wherein said convoluted body wall comprises a retractably extensible convoluted body wall which allows adjustment of the length of said tubular flexible body along said longitudinal axis.

35. A device to establish an electrical conductor in a conduit as described in claim 34, wherein said retractably extensible convoluted body wall comprises a plurality of opposed frustoconical segments, wherein each of said plurality of opposed frustoconical segments comprises a pair of frusta joined the greater diameter ends, and wherein said plurality of opposed frustoconical segments join at the lesser diameter ends to establish said hollow interior of said flexible body.

36. A device to establish an electrical conductor in a conduit as described in claim 35, wherein said plurality of opposed frustoconical segments comprise a substantially rigid material.

37. A device to establish an electrical conductor in a conduit as described in claim 36, wherein said frustoconical wall has a wall thickness, and wherein said wall thickness increases as said frustoconical wall converges from said greater diameter ends toward said lesser diameter ends.

38. A device to establish an electrical conductor in a conduit as described in claim 37, wherein adjustment of said frustoconical wall thickness from said greater diameter ends toward said lesser diameter ends allows said retractably extensible convoluted body wall to maintain a last chosen extended condition.

39. A device to establish an electrical conductor in a conduit as described in claim 38, wherein adjustment of said frustoconical wall thickness from said greater diameter ends toward said lesser diameter ends allows said retractably extensible convoluted body wall to maintain a last chosen a last chosen retracted condition.

40. A device to establish an electrical conductor in a conduit as described in claim 39, wherein adjustment of said frustoconical wall thickness from said greater diameter ends toward said lesser diameter ends allows said retractably extensible convoluted body wall to maintain a last chosen flexed condition.

41. A device to establish an electrical conductor in a conduit as described in claim 34, wherein said retractably extensible convoluted body wall which allows adjustment of the length of said tubular flexible body along said longitudinal axis comprises a plurality of annular ribs spaced a distance apart along said longitudinal axis of said flexible tubular body, and wherein adjustment of the length of said tubular flexible body along said longitudinal axis comprises extension of said flexible body wall between a pair of said plurality of annular ribs.

42. A device to establish an electrical conductor in a conduit as described in claim 28, wherein said first terminal portion of said flexible body configured to provide a first aperture element which couples to said end of said conduit comprises a resiliently flexible neck.

43. A device to establish an electrical conductor in a conduit as described in claim 28, wherein said first terminal portion of said flexible body configured to provide a first aperture element which couples to said end of said conduit comprises a resiliently flexible neck.

44. A device to establish an electrical conductor in a conduit as described in claim 43, wherein said flexible neck further comprises a slot, and wherein said flexible neck has sufficient flexure to allow a slot width of said slot to vary in response to engagement with said end of said conduit.

45. A device to establish an electrical conductor in a conduit as described in claim 44, wherein said neck having said slot, further comprises a spiral thread coupled to the interior surface of said neck having said slot, and wherein said spiral thread has a configuration which mates with said end of said conduit.

46. A device to establish an electrical conductor in a conduit as described in claim 28, wherein said first terminal portion of said flexible body configured to provide a first aperture element which couples to said end of said conduit comprises:
i. a tubular neck;
ii. a collar rotationally engaged to said tubular neck,
iii. a first annular flange connected to the exterior surface of said tubular neck;
iv. a second annular flange connected to the interior surface of said collar, wherein said first annular flange and said second annular flange engage to limit travel of said collar at a location along the longitudinal axis of said flexible body which allows a portion of said collar to extend beyond the end of said tubular neck; and
v. a spiral thread coupled to the interior surface of said collar, wherein said spiral thread has a configuration which mates with said end of said conduit.

47. A device to establish an electrical conductor in a conduit as described in claim 28, wherein said first terminal portion of said flexible body configured to provide a first aperture element which couples to said end of said conduit comprises:
i. a tubular neck; and
ii. a variably adjustable compression collar coupled to the exterior surface of said tubular neck which operates to alter configuration of said first aperture element which couples to said end of said conduit.

48. A device to establish an electrical conductor in a conduit as described in claim 28, wherein said second terminal portion of said flexible body having a second aperture element configured to allow said electrical conductor to pass through comprises a frusta, wherein the lesser diameter end of said frusta joins said flexible body.

49. A device to establish an electrical conductor in a conduit as described in claim 48, wherein said frusta has a frustoconical configuration which diverges toward said lesser diameter end at an angle relative to the longitudinal axis of said flexible body of between about 10 degrees and about 45 degrees.

50. A device to establish an electrical conductor in a conduit as described in claim 28, wherein said flexible body has a minimum length which provides a measure to identify a location on said electrical conductor at which to cut said electrical conductor.

51. A device to establish an electrical conductor in a conduit as described in claim 34, wherein said retractably extensible convoluted body wall allows adjustment of the length of said tubular flexible body to provide an adjustable measure which identifies a range of locations on said electrical conductor at which to cut said electrical conductor.

52. A device to establish an electrical conductor in a conduit as described in claim 28, wherein said flexible tubular body wall comprises a material selected from the group consisting of: a thermoplastic material, a Teflon, PVDF, a FEP teflon, a PFA teflon, a PTFE teflon, PVC, braid reinforced PVC, Santoprene, polyetylene, polypropelene, high density polyethylene, a high density polyethylene with between about 10% and about 35% polypropylene, a high density polyethylene with between about 15% polypropylene, a Viton®, a polyurethane, a nylon, a nylon 11, a vinyl, a polybutylene, and a PEEK.
